(19) United States
(12) Patent Application Publication
(10) Pub. No.: US 2013/0074482 A1
(43) Pub. Date: Mar. 28, 2013

(54) EXTRACTION OF HOT GAS FOR REAGENT VAPORIZATION AND OTHER HEATED GAS SYSTEMS

(71) Applicants: Sean T. Okamoto, Irvine, CA (US); Patrick J. King, Porter Ranch, CA (US); Dean A. Yonemori, Redondo Beach, CA (US)

(72) Inventors: Sean T. Okamoto, Irvine, CA (US); Patrick J. King, Porter Ranch, CA (US); Dean A. Yonemori, Redondo Beach, CA (US)

(21) Appl. No.: 13/702,556

(22) PCT Filed: Jun. 8, 2011
(86) PCT No.: PCT/US11/39643

§ 371 Date: Dec. 6, 2012

Related U.S. Application Data
(60) Provisional application No. 61/353,111, filed on Jun. 9, 2010.

(51) Int. Cl. F01N 5/02; F01N 3/30; F02B 35/00

(52) U.S. Cl. CPC F01N 5/02; F02B 35/00; F01N 3/30
USPC 60/316; 60/317

(57) ABSTRACT

A method to extract hot exhaust gas from the exhaust flue and use its heat energy to vaporize aqueous reactive reagents such as aqueous ammonia or to provide a heated air process gas mixture. Compressed air provides motive force to induce a vacuum in an ejector venturi device which draws hot exhaust gas (“hot gas”) from the exhaust flue. In one embodiment the hot gas is drawn into a vaporizer unit. The heat energy in the hot gas vaporizes the injected aqueous reagent. The vaporized mixture is drawn into the ejector and is entrained in the motive air. The diluted reagent vapor mixture is injected back into the exhaust flue to support the selective catalytic reduction (SCR) process and reduce nitrogen oxide (NOx).

### CROSS-REFERENCE TO PRIOR APPLICATIONS

This application is based on and claims the priority and benefit of U.S Provisional Application 61/353,111 filed on 9 Jun. 2010 which is incorporated herein by reference to the extent allowed by applicable law.

### U.S. GOVERNMENT SUPPORT

Not applicable.

### BACKGROUND OF THE INVENTION

1. Area of the Art

The present invention is in the art of handling hot exhaust gases, using exhaust gas heat and controlling air pollution in an energy efficient manner and relates in general to the reduction of the concentration of oxides of nitrogen (“NOx”) in the exhaust from combustion processes. In particular, the present invention relates to a new and useful method and system for the reduction of exhaust NOx concentration through the use of a hot gas extraction system and a related system for vaporization of reactive reagents, such as aqueous ammonia.

2. Description of the Background Art

The selective catalytic reduction (SCR) process is widely used to treat NOx (i.e., reduce the quantity of the pollutant) present within the exhaust from combustion processes. These combustion processes include, but are not limited to, energy generation from gas turbines and boilers, chemical process heaters and steam generation. The SCR process is a proven technology in which the NOx molecules in the exhaust combine with ammonia in the presence of a catalyst to form non-hazardous compounds.

Aqueous ammonia is the most common form of ammonia used for SCR, and it has become widely accepted as the safest form as well. Aqueous ammonia is a mixture of pure ammonia (NH₃—a gas) dissolved in liquid water. Concentrations of ammonia in aqueous ammonia range from as little as a few percent to about 10% to 35% by weight of ammonia.

However, ammonia gas is hazardous and the process of dissolving it in water is not always trivial. Urea had developed as an alternative reagent in the SCR process. Urea is a relatively non-toxic ammonia precursor and is readily soluble in water. When a urea solution is vaporized and heated, reactive ammonia is released. Other water soluble ammonia precursor reagents or other chemical reactants can be used in the same manner.

To maximize effectiveness of the SCR process the aqueous ammonia must be uniformly mixed with the exhaust stream. To ensure uniform mixing, it is necessary for the aqueous ammonia to be vaporized, diluted with a carrier gas, and evenly injected into the exhaust stream.

The aqueous reactive reagent vaporization process must be provided with ample amounts of heat energy due to the large relative volume of water vaporized for each useful volume of reagent supplied. The art has developed several methods to perform this vaporization. One such method is commonly referred to in the industry as “Gas Recirculation” or “Hot Gas Recirculation” vaporization. The operation of this prior art method is illustrated in FIG. 1.

The Gas Recirculation method of vaporization uses heat energy from hot exhaust gases that are usually expelled to the atmosphere thereby wasting the energy they contain. An extraction fan 22 withdraws a continuous stream of hot gas from the exhaust flue 10 of a combustion source through a hot source gas pipe 20. The exhaust flue 10 comprises a region 12 consisting of upstream or untreated flue gas and a region 16 downstream of an SCR reactor 14 consisting of treated flue gas. The gas extraction fan 22 moves the hot gas through itself into vaporizer pipe 24 which leads to a vaporizer unit 26. A metered amount of aqueous reactive reagent (such as ammonia) from a reagent source 30 is introduced into the vaporizer unit 26 by means of a reagent conduit pipe 32. The reagent is sprayed into the gas stream by a reagent spray nozzle 28 which uses compressed air conveyed from a compressed air source 34 to the nozzle 28 by an air conduit 36 for aqueous reagent atomization and for cooling the nozzle 28. The atomized aqueous reagent liquid is exposed to the hot gas for an adequate residence time to allow it to vaporize. The hot gas and reagent mixture exits the vaporizer unit 26 through an injector lance input conduit 38 and is then introduced back into the exhaust flue 10. The mixture is distributed evenly upstream of the SCR reactor 14 by means of a bank of injector lances 18. It will be apparent to one of ordinary skill in the art that this same arrangement can be used to introduce aqueous urea or any other aqueous solution of ammonia precursor reagent or other chemical reactant.

Gas-recirculation vaporization systems are simple in concept but rely upon a centrifugal-type extraction fan for transport and pressurization of the hot gas. This type of fan is a high speed rotational device comprised of precision components which are sensitive to high temperatures and/or caustic or reactive reagents and gases. The design features sensitive to high temperatures and reagents include, but are not limited to:
Cantilever impeller drive shafts;
Drive shaft bearing clearances;
Drive shaft casing seals;
Impeller hub-to-shaft mounting;
Drive shaft bearing pedestal;
Impeller-to-casing clearance; and
Impeller casing-to-pedestal mounting.

Gas extraction fan failures attributed to the shortcomings of these and other components have been a driving force to restrict use of the “gas-recirculation” vaporization system in the industry. To return gas-recirculation vaporization to a viable option, some means to address these issues in a cost-effective manner is needed.

### SUMMARY OF THE INVENTION

The present invention circumvents the failure modes associated with rotating equipment exposed to hot gas by replacing the extraction fan with an ejector venturi device (“ejector”—also known as “eductor,” “venturi” or “nozzle”) and a compressed air device not in contact with the high-temperature process (flue) gases.

Devices of the present invention can advantageously be used in both new and retrofit installations where the improved configuration may improve vaporizer performance and may reduce time required for system warm-up by moving the vaporization vessel from the extraction fan discharge as shown in FIG. 1 to the ejector suction pipe immediately adjacent to the exhaust flue.

Furthermore, the ejector venturi device can also be used advantageously in a number of configurations where it is used to replace vulnerable gas extraction fans. The ejector venturi device can advantageously be used in a variety of applications to move hot exhaust gases without contacting a vulnerable extraction fan. Another advantage of the inventive technology is that it can be reliably applied to flue gas temperatures higher than possible with the prior art technology which makes it potentially more efficient.

### DESCRIPTION OF THE FIGURES

FIG. 1 shows a diagram of a prior art gas recirculation vaporization system;

FIG. 2 shows first “downstream” embodiment, often used in original equipment, of the present invention wherein an ejector is downstream of the vaporizer;

FIG. 3 shows a second “upstream” embodiment of the present invention, often used in retrofits, wherein an ejector is upstream of the vaporizer;

FIG. 4 shows a prior art heat seal-air system; and

FIG. 5 shows a heat seal-air system wherein an ejector provides heat for the air barrier.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide improved gas-recirculation vaporization and other hot gas systems.

The present invention includes a variety of configurations using an ejector to avoid the problems of handling hot gases with a fan. One use of extracted hot gases is to effect reagent vaporization. The reagent vaporization embodiments include ones with a vaporizer upstream of the ejector and ones with a vaporizer downstream of the ejector. Hot gases extracted with an ejector can be used in various applications to avoid contact between a fan and hot reactive gases and to avoid or minimize the use of external heaters to increase gases to a working temperature as in, for example, a heated seal-air system.

Upstream Installation

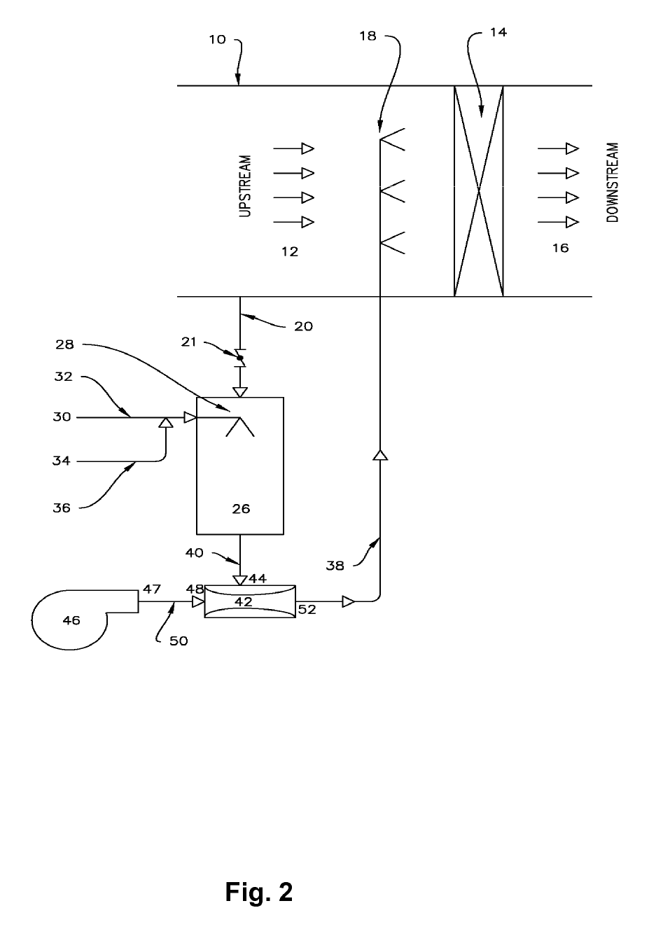

FIG. 2 illustrates the invention installed in an upstream configuration which is usual, but not required, in an original equipment installation. This configuration provides reactive reagent vaporization using hot gas without placing an extraction fan directly in the flow path of the hot gas. In the device air at ambient conditions is compressed to 10 psig to 30 psig (69 kPa-207 kPa) by a blower 46. One of ordinary skill in the art realizes there are a number of similar compressor or blower devices that can be used in this system. During compression, the air temperature increases as a function of the temperature of ambient air at the blower intake and blower compression ratio. Expected air temperature at the exit 47 of the blower/compressor is from about 100° F. to 350° F. (38° C. to 177° C.). This “warm” compressed air is forced through an insulated air pipe 50 to the venturi ejector device 42 “motive air” input or entry port 48. The warm compressed air passes through the ejector venturi device 42 thereby inducing a vacuum at the ejector “suction gas” or vacuum inlet port 44 of the ejector device 42.

Typical hot gas temperature within the exhaust flue 10 will vary between about 500° F. (260° C.) and 1,100° F. (593° C.) as a function of the particular combustion process and precise location of hot gas removal from ductwork 10. Temperatures above 900° F. (482° C.) are typical at the flue gas take-off location at the gas turbine discharge in simple cycle operation or upstream of the Heat Recovery Steam Generator (HRSG) on a gas turbine in cogeneration operation. Hot gas temperatures above 500° F. (260° C.) are typical at the flue gas take-off location downstream of the gas turbine in Co-Generation operation with a Heat Recovery Steam Generator (HRSG) installed.

A continuous stream of hot gas is drawn from the flow of hot gas in the exhaust flue 10 through an insulated gas inlet pipe 20 by the vacuum developed by the ejector device 42. The flow rate of hot gas is typically regulated by an automatic valve 21. The setting of the automatic valve 21 is a function of flow rate and pressure at ejector output port 52 and temperature at injector lance input conduit 38. The hot gas is drawn through the insulated hot gas source pipe 20 into a vaporizer unit 26. The vaporizer unit 26 may be an open-chamber type with liquid spray nozzle, structured packing type, random packing type, tray-column type, static mixer type, or other configuration known to those of ordinary skill in the art who will understand that these and other configurations of vaporizer are completely applicable to the current invention. It will be understood that placement of the vaporizer unit 26 can be varied to “tune” the temperature. At this point a metered amount of aqueous reactive reagent from a reagent source 30 is introduced into the vaporizer unit 26 through the reagent conduit pipe 32. The aqueous reagent is sprayed into the gas stream by a reagent spray nozzle 28 powered by compressed air from a compressed air source 34 at about 15 psig to 30 psig (103 kPa-207 kPa) thereby providing fine aqueous reagent atomization. The spray nozzle 28 exterior is shielded from the hot gas by an outer sheath (not shown) with cool air flowing between the nozzle and the sheath. Compressed air is supplied to the nozzle 28 through a pipe 36 connected to the air source 34. The atomized aqueous liquid reagent solution is contacted by the hot gas where there is adequate residence time to allow the reagent to vaporize. One of ordinary skill in the art will understand that the above spray nozzle description is given for illustration purposes and other configurations of reagent sprayers (for example, mechanical nozzles and ultrasonic atomizers) are completely applicable to the current invention.

The vaporization function is improved by locating the vaporizer adjacent to the exhaust flue thus exposing the aqueous reagent to the highest possible hot gas temperature. The hot gas and reagent mixture is then drawn out of the vaporizer unit 26 and through an insulated vaporizer to ejector pipe 40.

The mixture enters the “suction” or inlet port 44 of the ejector device 42 and becomes mixed with the “motive air” from a dilution fan or blower 46. The diluted mixture exits the ejector device 42 at the output or “discharge” port 52. The diluted mixture temperature will vary as a function of “motive air” flow into the entry port 48, ambient temperature plus the blower heat of compression (as measured in the air conduit pipe 50), “suction gas” flow through the inlet port 44, and reagent mixture temperature (as measured in the pipe 40). Typical diluted mixture temperature at ejector output port 52 will vary according to process conditions and reagent flow rates but is typically about 190° F. to 600° F. (88° C. to 316° C.).

The minimum required mixture temperature in the pipe 40 is a function of hot gas composition. Sulfur bearing hot gas should typically remain above 500° F. (260° C.). Non-sulfur bearing hot gas temperature is a function of the calculated dew point of the vaporized chemical reagent within the gas mixture in pipe 40.

The diluted mixture is re-introduced into the exhaust flue 10 through an insulated injector lance input conduit 38. The mixture is distributed evenly upstream of the SCR reactor 14 by means of a bank of injector lances 18. Reaction of the NOx with the ammonia or other reactive reagent then occurs within the SCR reactor 14.

Downstream Installation

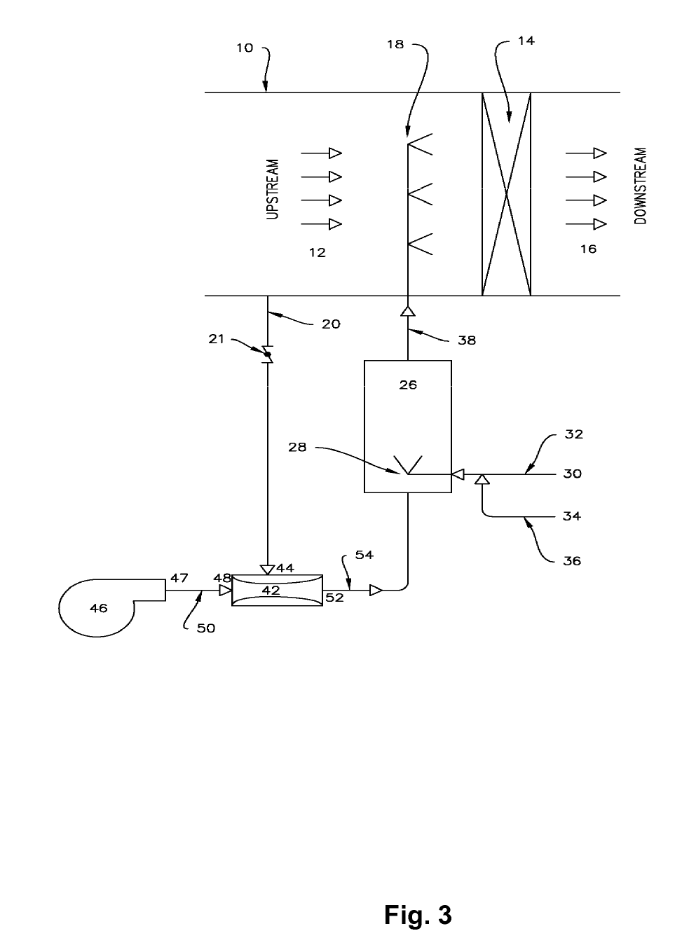

The invention as illustrated in FIG. 3 provides reactive reagent vaporization by using hot gas without placing an extraction fan directly in the flow path of the hot gas. This embodiment has a downstream placement of the vaporizer unit and may be a convenient configuration for replacing an extraction fan in an existing installation (i.e., a “retrofit” installation). However, this configuration is also useful in a new installation depending on process parameters. In this embodiment air at ambient conditions is compressed to 10 psig to 30 psig (69 kPa-207 kPa) with a blower 46. One of ordinary skill in the art realizes there are a number of similar compressor or blower devices that can be used in such a system such as, for example, a multistage centrifugal, positive displacement, high-speed turbo-blower.

During compression, the air temperature increases as a function of the temperature of ambient air at the blower intake and blower compression ratio. Expected air temperature at the exit 47 of the blower/compressor is from about 100° F. to 350° F. (38° C. to 177° C.). This “warm” compressed air is forced through an insulated air pipe 50 to the venturi ejector device 42 “motive air” input or entry port 48. The warm compressed air passes through the ejector venturi device 42 thereby inducing a vacuum at the ejector “suction gas” or vacuum inlet port 44 of the ejector device 42.

Temperatures below an ideal temperature for a given process can be increased using an auxiliary electric or gas-fired air heater, a bypass valve which diverts a portion of the blower/compressor discharge flow back into the blower/compressor inlet line, a bypass valve which diverts a portion of the extracted flue gas from the vaporizer unit inlet line back into the blower/compressor inlet line, a combination of these methods, or other similar methods.

A continuous stream of hot gas is drawn from a flow of hot gas in the exhaust flue 10 through an insulated hot gas inlet pipe 20 by the vacuum developed by the ejector device 42. Typical hot gas temperature within the exhaust flue 10 will vary between about 500° F. (260° C.) and 1,100° F. (593° C.) as a function of the particular combustion process and precise location of hot gas removal from ductwork 10. Temperatures above 900° F. (482° C.) are typical for at the flue gas take-off location at the gas turbine discharge in simple cycle operation or upstream of the Heat Recovery Steam Generator (HRSG) on a gas turbine in cogeneration operation. Hot gas temperatures above 500° F. (260° C.) are typical at the flue gas take-off location downstream of the gas turbine in Co-Generation operation with a Heat Recovery Steam Generator (HRSG) installed.

The hot gas is drawn into the “suction” port 44 of the ejector device 42. The flow rate of hot gas is typically regulated by an automatic valve 21. The setting of the automatic valve 21 is a function of flow rate and pressure at ejector discharge port 52 and temperature at ejector pipe 54. The hot gas becomes mixed with the “motive air” from the dilution blower 46. The diluted gas exits the ejector device 42 at the output or “discharge” port 52. The diluted gas temperature will vary as a function of “motive air” flow into the entry port 48, ambient temperature plus the blower heat of compression (as measured in air pipe 50), “suction gas” flow through inlet port 44, and hot flue gas temperature (as measured in the pipe 20). Typical diluted mixture temperature at exit port 52 can be about 300° F. to 750° F. (149° C. to 399° C.).

The mixture exits the ejector device 42 through an insulated gas pipe 54 into a vaporizer unit 26. At this point a metered amount of aqueous reactive reagent from a reagent source 30 is introduced into the vaporizer unit 26 through a reagent pipe 32. The aqueous reagent is sprayed into the gas stream by a reagent spray nozzle 28 powered by compressed air conducted by an air pipe 36 from an air source 34 at about 15 psig to 30 psig (103 kPa-207 kPa) thereby providing fine aqueous reagent atomization. The exterior of the spray nozzle 28 is shielded from the hot gas by an outer sheath (not shown) with cool air flowing between the nozzle 28 and the sheath. The atomized aqueous reagent solution is contacted by the hot gas where there is adequate residence time to allow the reagent to vaporize. One of ordinary skill in the art will understand that the nozzle system is shown for illustration purposes only. Any other method of atomizing the liquid reagent is applicable to the current invention.

The hot gas and reagent mixture flows out of the vaporizer unit 26 into an insulated pipe 38. The minimum required mixture temperature in the pipe 38 is a function of hot gas composition. Typically, sulfur bearing hot gas should remain above 500° F. (260° C.). Non-sulfur bearing hot gas temperature is a function of the calculated dew point of the vaporized chemical reagent within the gas mixture in pipe 38. The diluted mixture is re-introduced into the exhaust flue 10. The mixture is distributed evenly upstream of the SCR reactor 14 by using a bank of injector lances 18. Reaction of the NOx with ammonia or other reactive reagent then occurs within the SCR reactor 14.

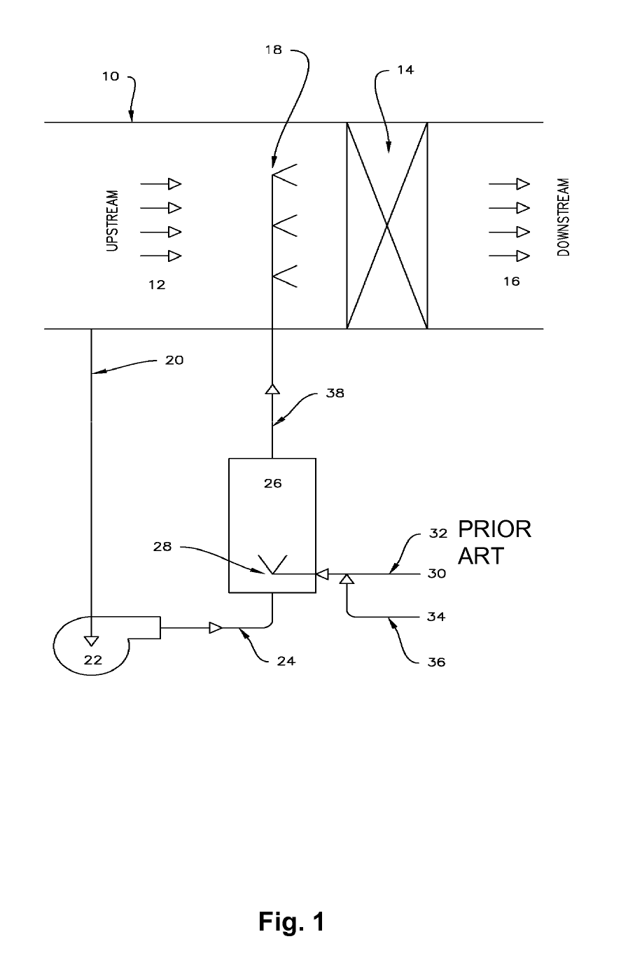

It will be apparent to one of ordinary skill in the art that the configuration differences between this embodiment and the upstream embodiment are primarily due to the configuration of the prior art arrangement (FIG. 1). In the prior art arrangement a fan 22 draws hot gases from the exhaust flue 10 and forces this gas stream into the vaporizer unit 26 where a reagent is sprayed into the gas stream (vaporizer is downstream from the fan). Then the mixture of flue gas and vaporized reagent is reintroduced upstream of the SCR unit 14. In the embodiment of FIG. 2 the fan 22 is replaced by an ejector 42 and blower 46 which draws the hot gases from the exhaust flue 10 directly into the vaporizer unit 26 (vaporizer is upstream from the ejector). The mixture of hot gas and vaporized reagent is drawn into the ejector 42 and forced out of the ejector to be reintroduced into the exhaust flue 10 upstream of the SCR unit 14. This arrangement may produce higher gas temperatures in the vaporizer unit because gases are drawn directly from the exhaust flue. The temperature of gas forced out of the ejector and back into the exhaust flue can be controlled by regulating the flow of hot flue gas by setting of automatic valve 21.

When it is desired to replace a failing hot gas fan of the prior art (FIG. 1) with an ejector 42 to avoid future hot gas-caused failures, the system is already configured with the vaporizer unit 26 downstream from the device that moves the hot gas. It is much simpler to replace the hot gas fan 22 directly with a blower ejector combination because this avoids moving the vaporizer and replacing all the attendant plumbing. As explained above, the position of the vaporizer upstream of the ejector can be advantageous because the hot gas entering the vaporizer directly from the exhaust flue as well as the partial vacuum produced by the ejector promote reagent vaporization. When a downstream position of the vaporizer is adopted as in a replacement scenario, relocating the penetration of the hot gas inlet pipe 20 to a hotter region in exhaust flue 10 can be used to ensure a sufficiently high temperature for optimal reagent vaporization. Auxiliary heating of incoming blower air and/or extracted hot gas are other useful alternatives to ensure sufficiently high temperatures for optimal reagent vaporization.

Elector-Based Heated Seal-Air System

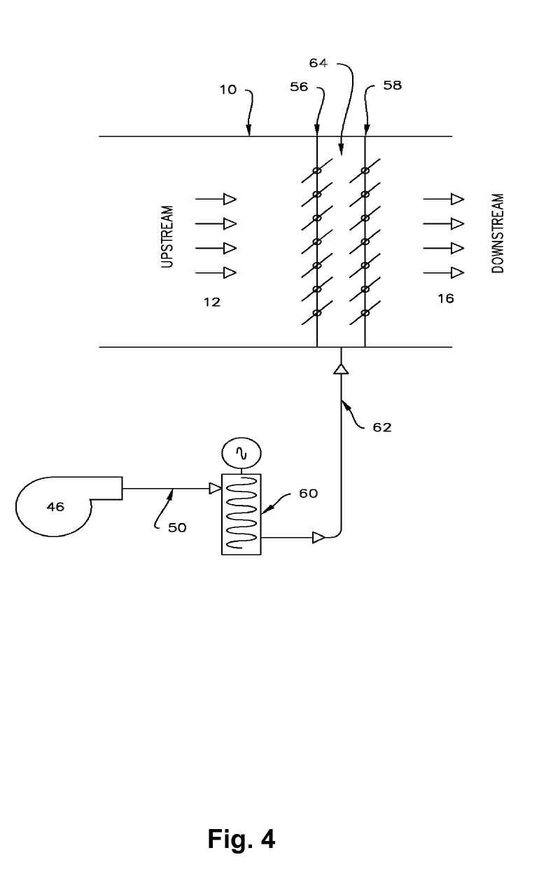

Hot gas drawn by an ejector can also be used as an energy saving system for heating ambient air. FIG. 4 shows a prior art heated seal-air system. Such a system is used with a bank of dampers 56, 58 in controlling, for example, hot exhaust gas in a duct 10. The prior art solution utilized a double layer of dampers to maximize gas isolation of the upstream side 12 of a first set 56 of dampers from the downstream side 16 of a second set 58 of dampers. To further improve isolation, the space 64 between the upstream dampers 56 and the downstream dampers 58 is purged with ambient air. A blower 46 compresses the air to a pressure above that present in the ductwork. It is common for the duct gas isolated by these dampers to contain chemicals that form acidic or other corrosive liquids at temperatures below the dew point. To minimize this occurrence, the ambient air is heated by an electric heater 60 to ensure that the gas in contact with the upstream dampers 56 does not become cooled below the dew point. Unfortunately, the air heater 60 expends a considerable amount of energy in heating the air.

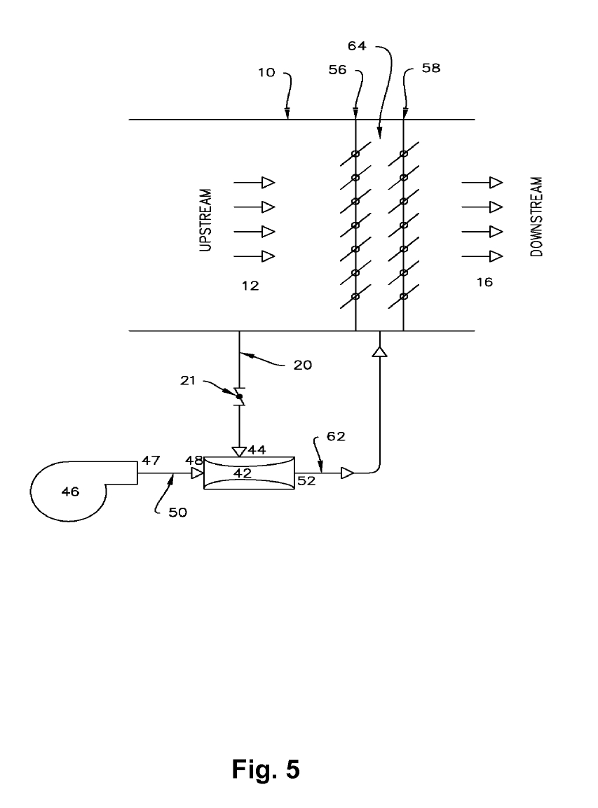

FIG. 5 shows the inventive arrangement where the ambient air is drawn into blower 46. The compressed air is forced into the inlet port 48 of the venturi ejector 42 through a pipe 50. The air flow through the ejector 42 induces a vacuum in a pipe 20 which draws hot gas from the duct 10 and into the venturi ejector suction inlet port 44. The flow rate of hot gas can regulated with an automatic valve 21. The setting of the automatic valve 21 is a function of flow rate and pressure at ejector output port 52 and temperature at ejector outlet pipe 62. The hot gas mixes with the compressed air to provide heated air for the seal air purposes. The heated mixture exits the venturi ejector 42 by way of a discharge port 52 and ultimately is conveyed by means of a pipe 62 to the space 64 between upstream dampers 56 and downstream dampers 58. Thus, the air heater 60 is eliminated with considerable saving in energy. It will be appreciated that the ejector allows the barrier gas to be heated without requiring an auxiliary heater, thus saving energy. The ejector system is applicable to other configurations where heated gas is needed.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

What is claimed is:

1. A system for vaporizing reactive reagents for use in selective catalytic reduction systems without any moving mechanical parts becoming exposed to hot exhaust flue gas and/or reactive reagent vapor comprising:
a first source of compressed gas;
a venturi ejector having an input port, a suction port and an output port with the first source of compressed gas providing compressed gas to the input port;
a hot gas inlet pipe for providing hot gas from an exhaust flue;
a hot gas outlet pipe for reintroducing a gas mixture into the exhaust flue downstream of the hot gas inlet pipe whereby a vacuum at the suction port draws hot gas from the exhaust flue and through the hot gas inlet pipe and the compressed gas and hot gas mixture exiting the outlet port is forced through the hot gas outlet pipe and back into the exhaust flue; and
a reaction vessel having a gas inlet and a gas outlet disposed between the hot gas inlet pipe and the hot gas outlet pipe in fluidic communication therewith, the reaction vessel comprising:
a reactive reagent atomizing device within the reaction vessel; and
a source of reactive reagent operatively connected to the reactive reagent atomizing device.

2. The system according to claim 1, wherein the atomizing device further comprises a reactive reagent spray nozzle for spraying reactive reagent from the source of reactive reagent and a second source of compressed gas operatively connected to the reactive reagent spray nozzle.

3. The system according to claim 1, wherein the reaction vessel is disposed with the gas inlet connected to the hot gas inlet pipe and the gas outlet connected to the suction port whereby a vacuum produced in the venturi ejector draws hot gas from the exhaust flue into the reaction vessel where the hot gas mixes with a reactive reagent spray from the reactive reagent atomizing device resulting in vaporization of the reactive reagent to form a hot gas-reactive reagent mixture which is drawn into the venturi ejector and is propelled back into the exhaust flue by way of the hot gas outlet pipe connected to the output port.

4. The system according to claim 1, wherein the reaction vessel is disposed with the gas inlet connected to the output port of the venturi ejector and the gas outlet connected to the hot gas outlet pipe whereby a vacuum produced in the venturi ejector draws hot gas from the exhaust flue into the venturi ejector where the hot gas mixes with gas from the first source of compressed gas and exits the venturi ejector into the reaction vessel to mix with a reactive reagent spray from the reactive reagent atomizing device resulting in vaporization of the reactive reagent to form a hot gas-reactive reagent mixture which is propelled through the hot gas outlet pipe back into the exhaust flue.

5. The system according to claim 1, further comprising means for heating compressed gas from the first source.

6. A system for providing a heated air and process gas mixture:
a source of compressed air;
a venturi ejector having an input port, a suction port and an output port with the source of compressed air providing compressed air to the input port;
a hot gas inlet pipe connected between a source of hot gas and the suction port;
a heated process gas mixture outlet pipe making fluidic connection between the output port of the venturi ejector and a process which requires a heated air and process gas mixture, whereby a vacuum produced in the venturi ejector draws hot gas into the venturi ejector where it is mixed with and heats the compressed air to provide the required heated air and process gas mixture.

7. The system according to claim 6, further comprising two sets of spaced apart dampers within an exhaust flue where the heated air and process gas mixture from the heated process gas mixture outlet port provides heated seal-air between the two sets of dampers.
